(19) United States
(12) Patent Application Publication
(10) Pub. No.: US 2022/0036678 A1
(43) Pub. Date: Feb. 3, 2022

(54) SYSTEMS, DEVICES AND METHODS OF COLLECTING INFORMATION VIA TOUCHLESS TECHNOLOGY TO CONTROL ACCESS TO PHYSICAL SPACES

(71) Applicant: Viraat Authentication Systems Inc., New York, NY (US)

(72) Inventor: Kunal Parekh, Mumbai (IN)

(21) Appl. No.: 17/391,169

(22) Filed: Aug. 2, 2021

Related U.S. Application Data
(60) Provisional application No. 63/059,713, filed on Jul. 31, 2020.

(51) Int. Cl. G07C 9/25; G06F 21/36; G06F 21/32; G06F 3/01; G06K 9/00; G06Q 10/10

(52) U.S. Cl. CPC G07C 9/25; G06F 21/36; G06F 21/32; G06Q 10/1095; G06K 9/00288; G06K 9/00355; G06K 9/00375; G06F 3/017

(57) ABSTRACT

A computer-implemented method of controlling access to a controlled area using a touchless experience includes under control of one or more configured computing devices, generating a QR code that is linked with the individual, and transmitting the QR code to an electronic device that is under the control of the individual. The method includes capturing an image of the QR code transmitted to the electronic device that is under the control of the individual and evaluating the captured QR code for determining whether the captured QR code matches the QR code transmitted to the electronic device that is under the control of the individual. The method includes obtaining a skin temperature reading for the individual, and capturing a facial image of the individual, and evaluating the captured facial image for determining whether the individual is wearing a face mask. The method includes generating an electronic signal to admit the individual into the controlled area if the captured QR code matches the QR code transmitted to the individual, if the skin temperature reading obtained for the individual is within an acceptable skin temperature range, and if the individual is wearing a face mask. A method may include using one or more timers for controlling how long visual images are displayed on a visual display screen. Touchless, physical gestures are used for progressing between the visual images are displayed on the visual display screen.

### CROSS-REFERENCE TO RELATED APPLICATIONS

The present patent application claims benefit of U.S. Provisional Application Ser. No. 63/059,713, filed on Jul. 31, 2020, the disclosure of which is hereby incorporated by reference herein. The present patent application is related to U.S. patent application Ser. No. 17/216,320, filed on Mar. 29, 2021, the disclosure of which is hereby incorporated by reference herein.

### BACKGROUND OF THE INVENTION

### Field of the Invention

The present patent application is generally related to taking user inputs in a touchless or hands-free manner users via kiosks, touchscreen devices and/or non-touch devices. The systems, devices and methods disclosed herein may be used for, but are not limited to, controlling access to buildings and physical spaces, and is more particularly related to using hands free technology for monitoring the health and personal protective equipment status of individuals who seek to gain access to buildings and enclosed spaces.

### Description of the Related Art

Individuals use touch screens all over the globe to interact with systems.

As a result of the COVID 19 pandemic, people are now worried about touching any screens that are used publicly by third parties. Due to the unsanitary nature of the touch screens, they run the risk of transferring the Corona virus through multiple users using the same screen.

In the Covid era, controlling and monitoring access to buildings and indoor spaces is critical. There have been a number of developments related to monitoring employees and visitors for controlling access to buildings and indoor spaces.

For example, JP2010128976 discloses an access control system for preventing a pathogen from entering a building and rooms when an infectious disease breaks out. The access control system includes an IC tag that is integrated into an employee identification to store and transmit a tag ID unique to the IC tag. A control server is installed in an internal area to transmit a message whether to permit passing of a gate to each antenna in response to an external message. Each antenna stores a unique antenna ID, and when the IC tag approaches, receives the tag ID, transmits it as well as the antenna ID to the control server, and opens each gate in response to the message from the control server. An infrared camera measures the body temperature of a person and transmits the body temperature data to the control server. An image recognition camera acquires face image data of the person to determine whether a mask is worn and transmits the determination result to the control server. A washstand W is used for the person to wash hands and transmits a message of hand washing to the control server.

JP2019124012 discloses an automatic door that is configured to prevent a person that is in bad health from entering a room. The automatic door has a health condition presumption section that presumes a health condition of a passenger based upon a combination of one or more variables including face color, gait, body surface temperature, heart rate, weight, and the odor of the passenger. The automatic door will open if the passenger satisfies the predetermined conditions to enter a room.

WO2017057274 discloses an elevator group management system. The system includes a security gate that is disposed at an entrance in a specific region of a building, which controls entry of a user of the building into the specific region. The security gate has a body temperature sensor that measures the body temperature of a user who is passing through the security gate. The system includes a security server that controls the opening and closing of a gate. When the body temperature measured by the body temperature sensor does not satisfy a predetermined body temperature condition, the security server controls the gate so that the entry of the user into the specific region is restricted.

U.S. Pat. No. 7,455,224 to Kochevar et al., the disclosure of which is hereby incorporated by reference herein, discloses a system for ensuring access management of a given site by providing integrated and comprehensive assessment of persons, livestock or objects that are given access to the site. The system includes a database of information about the site and potential accessors, a communication and scanning device to collect, retrieve and facilitate communication between the site as well as an administrator console. The system is flexible enough to maintain current information about the persons, livestock or objects requesting access to the site and communicating those results to the device user in real time. The system is further enabled through the Internet and the World Wide Web.

U.S. Pat. No. 9,317,662 to Bangera et al., the disclosure of which is hereby incorporated by reference herein, teaches methods, devices, and computer systems that are configured for automated data collection from a subject. In certain embodiments, one or more characteristics of a subject are sensed, and the subject is given a queue status indicator based on a comparison of the subject's one or more sensed characteristics with corresponding sensed characteristics from other subjects. In one embodiment, the subject is a healthcare worker, and the system, methods, and devices are utilized to evaluate the overall health of the worker as part of the check-in process for work.

There have also been advances in providing automated systems that monitor adherence to established protocols. For example, U.S. Pat. No. 10,361,000 to Johnson et al., the disclosure of which is hereby incorporated by reference herein, teaches a system for protocol adherence. The system provides an integrated and automated workflow, sensor, and reasoning system that automatically detects breaches in protocols, appropriately alarms and records these breaches, facilitates staff adoption of protocol adherence, and ultimately enables the study of protocols for care comparative effectiveness. The system provides real-time alerts to medical personnel in the actual processes of care, thereby reducing the number of negative patient events and ultimately improving staff behavior with respect to protocol adherence.

US 2016/0093127 to Evans, the disclosure of which is hereby incorporated by reference herein, discloses an entry point validation system. The system is implemented at entry points to controlled access areas, such as ticketed events, venues, buildings, rooms, elevators, and the like. One embodiment includes receiving a beacon identifier on a mobile device from a beacon device associated with an entry point. This embodiment includes transmitting, via a network from the mobile device, the beacon identifier and at least one identifier to a backend system with an entry request to electronically cause a credential to be provided to a computing device associated with an entry point.

U.S. Pat. No. 7,856,558 to Martin et al., the disclosures of which is hereby incorporated by reference herein, teaches a biometric verification and duress detection system. The system includes a first and second identification device to verify the identity of the user and to determine if the user is under duress. When a user approaches an entrance to a building, a first identifier is detected by the first identification device, and the first identifier is compared to a pre-stored identifier. If there is a match, the user inputs at least one biometric input into the second identification device. The biometric input is compares with pre-stored information in two different databases, a biometric template database and a duress indicator database. If there is a match with the duress indicator database, a silent alarm signal is transmitted to a central monitoring station and the security system is disarmed. If there is a match with the biometric template database, the security system is controlled in the intended manner.

US 2016/0248782 to Troesch, the disclosure of which is hereby incorporated by reference herein, teaches a system for controlling access by using portable electronic devices. The access control system is configured to detect the presence of a portable electronic device carried by a user in a first area. The access control system sends an access code to the device. In a second area, the user presents the portable electronic device to an access terminal, which reads the access code from the device. If the access code read from the device matches the access code that was sent to the device by the system, then the access control system grants access to the user.

U.S. Pat. No. 9,552,684 to Bacco et al., the disclosure of which is hereby incorporated by reference herein, teaches a security system that integrates physical and logical security controls for the protection of secured resources. The resources may include physical locations and/or computing resources such as databases containing personal information. In some embodiments, information is stored in separate, codependent databases such that by isolating the components of the databases from each other, a successful attack on one component is not sufficient to enable the access of content of the other components. In some embodiments, biometric information is automatically obtained as users approach an access location and is ready for expedited verification of identity upon request by the user.

Despite the above advances, there is a continuing need for improved access control systems, including automated touchless health-check screening systems that incorporate biometric and thermographic technology.

There is also a need for systems, devices, and methods that enable individuals to interact with technology and screens in a non-touch or hands-free manner.

### SUMMARY OF THE INVENTION

In one embodiment, systems, devices, and methods may be operated without requiring individuals to touch the screens.

In one embodiment, a computer-implemented method for authenticating an individual, screening an individual, and/or controlling access to a controlled area uses a touchless experience so that users do not have to physically contact components to be authenticated, screened and/or gain access to the controlled area.

The computer-implemented method may be controlled by one or more software programs that are used for controlling hardware, electronic devices, and computer systems.

In one embodiment, a method may include under control of one or more configured computing devices, obtaining a facial record of an individual, and storing the facial record of the individual in a facial recognition database.

In one embodiment, a method may include generating a QR code that is linked with the individual, and transmitting the QR code to an electronic device that is under the control of the individual.

In one embodiment, a method preferably includes, capturing an image of the QR code transmitted to the electronic device that is under the control of the individual. The image of the QR code may be captured when the individual seeks to gain access to the controlled area.

In one embodiment, the one or more configured computing devices evaluate the captured QR code for determining whether the captured QR code matches the QR code transmitted to the electronic device that is under the control of the individual.

In one embodiment, a method may include displaying a first visual image on a visual display screen during the step of capturing the image of the QR code transmitted to the individual.

In one embodiment, a method may include displaying a second visual image on the visual display screen during the step of obtaining the skin temperature reading for the individual.

In one embodiment, a method may include displaying a third visual image on the visual display screen during the steps of capturing the facial image of the individual and determining if the individual is wearing the face mask.

In one embodiment, a method may include using one or more timers for controlling how long the first, second and third visual images are displayed on the visual display screen.

In one embodiment, the one or more configured computing devices are desirably programmed for automatically advancing from displaying the first visual image to displaying the second visual image after a first predetermined time period that is monitored by the one or more timers.

In one embodiment, the one or more configured computing devices are programmed for automatically advancing from displaying the second visual image to displaying the third visual image after a second predetermined time period that is monitored by the one or more timers.

In one embodiment, a method may include using one or more timers for controlling how long the first, second and third visual images are displayed on the visual display screen.

In one embodiment, the one or more configured computing devices are programmed for automatically advancing from displaying the first visual image to displaying the second visual image after a first predetermined time period that is monitored by the one or more timers.

In one embodiment, the one or more configured computing devices are programmed for automatically advancing from displaying the second visual image to displaying the third visual image after a second predetermined time period that is monitored by the one or more timers.

In one embodiment, timers are used on each screen and replaced all the “Cancel” and “OK” buttons +“Close” buttons on popups. Once the timer runs down, the screen flows and/or advances to the next screen in the happy flow.

However, there was one issue with doing this with a single timer with a single countdown. Each screen would have different information to be read by the user and would take different amounts of time to read the same. So, we introduced a timer for each screen, which could be configured based on what was the objective or output required from each screen.

The introduction of configurable timers resolved our informational screen and error screen challenge. Ultimately, the user experience was of prime importance to us while implementing each change. And, consuming the same amount of time on each screen was not a great experience, as there is no button to “Skip.”

In one embodiment, a countdown timer is used on every display screen and/or popup and/or any visible portion of the screen, or as an extension of the screen or a separate display screen. In one embodiment, the screen may be extended via a wireless or wired technology. In one embodiment, the timer may count from a higher time to a lower time.

In one embodiment, the timer may be on the same system or any other integrated or non-integrated system.

In one embodiment, the timer may be used in a stopwatch mode. In one embodiment, the timer may count from a lower time to a higher time.

In one embodiment, the timer preferably replaces the function of the default button on the screen or popup screen.

In one embodiment, the timer preferably replaces the function of the escape button on the popup screen or screen.

In one embodiment, the screen counts down or up without a timer being visible.

In one embodiment, the screen may start the timer only when a user is detected in proximity to a component of a system (e.g., a kiosk, the first introduction screen).

In one embodiment, the countdown timer or stopwatch timer could be single for only a single screen or single across the entire process or single across a set of certain screens (e.g., answer the next three questions within 30 seconds, with each question being on a different screen), which could be consecutive or not.

In one embodiment, the timer may be different for different flows or a combination thereof (e.g., normal flow, error flow or no action flow or a combination of any or all three).

In one embodiment, the timer may be different for different sections of the screen flow (e.g., informational section, input section).

In one embodiment, the timer may be based on many more different parameters or combinations of parameters than the above examples.

In one embodiment, the timer may be different for the same screen if it repeats in the flow one or more times.

In one embodiment, the timer may be a single time across every screen (e.g., 10 seconds on each screen) or differently configured for each screen based on the information that needs to be read or the task that needs to be completed by the user.

In one embodiment, two or more things may be achieved on a single screen (e.g., capture a photograph of a user and detect if the user is wearing a face mask).

In one embodiment, the timer may be forwarded or rewound using a user input (e.g., a gesture by the user). In one embodiment, each gesture may forward or rewind the timer by the number of seconds configured (e.g., rewind by five (5) seconds or forward by five (5) seconds). In one embodiment, the configuration may be per screen. In one embodiment, if the timer runs out due to the gesture, then it would move to the next or previous screen in the flow.

In one embodiment, the screens may be configured based on three flows or combination of the three flows such as the normal flow, the alternate flow/exception flow, and the no action flow and/or combinations thereof.

In one embodiment, the flows may loop endlessly based upon how they are configured. In one embodiment, this may be important for instances where the touchless experience moves from a user to the next user.

In one embodiment, during the normal or happy flow, the user input may be required in all steps of the screens (e.g., scan QR code, measure temperature, and detect mask).

In one embodiment of the normal or happy flow, the user input may not be required at all (e.g., just informational screens to read with different timers on each screen (based on the content of the screen)).

In one embodiment of the normal or happy flow, the user input may result in faulty information being provided by the user or getting incorrect reading from the camera or the system not being able to read the information correctly from the camera. In either case, in one embodiment, this may activate the error flow of the screen and the user will be taken to an error screen or popup, where the user will be informed about the issue with the input. In one embodiment, each error screen or popup has a timer on the screen, which would make the popup or error screen disappear after the timer has run down and then move to the relevant screen, based upon the type of error.

In one embodiment the error may need the user to input on the same screen then, the system will wait on the same screen for the input (e.g., “The scanned QR code is incorrect. Please scan the correct QR code.” would require the person to be on the same screen).

In one embodiment, the error may require the user to go to a previous screen, then the screen flows to that screen where the input is required (e.g., “The scanned QR code is for a later time. Please check back close to the appointment”). After this step, the screen would flow back to the informational screens.

In one embodiment, the error may need the user to go to a completely different flow, then the user is moved to another section of the screen flow (e.g., if the temperature is high, then the user may be asked a set of multiple-choice questions such as “Are you suffering from taste or smell loss? Yes No”). In one embodiment, the user may answer the inquiry using a gesture to select one of the options. The questions may be a single or as many as configured in this flow and would have its own normal, error and no action flows. One option may be selected by default with a timer next to it and the screen would flow automatically to the next question if the user does not wish to change the default answer. Or the user may change it with one or more gestures before the screen automatically forwards/advances to the next screen. In one embodiment, the user may return to the previous screen by performing one or more gestures. The option select may be for ease of the user, or to force the user to select another answer (e.g., “Are you suffering from taste or smell loss? Yes/No”). In one embodiment, a timer on “yes” may force the user to change the answer, while a timer on “no” may provide ease of use.

In one embodiment, the method includes obtaining a skin temperature reading for the individual, such as by using a skin temperature monitor that is in communication with the one or more configured computing devices.

In one embodiment, a method may include capturing a facial image of the individual, such as when the individual seeks to gain access to the controlled area.

In one embodiment, the one or more configured computing devices and/or software programs may be used for evaluating the captured facial image for determining whether the captured facial image matches the facial record of the individual that is stored in the facial recognition database.

In one embodiment, the method may include generating an electronic signal to admit the individual into the controlled area if the captured QR code matches the QR code transmitted to the individual, if the captured facial image matches the facial record of the individual that is stored in the facial recognition database, and if the skin temperature reading obtained for the individual is within an acceptable skin temperature range.

In one embodiment, the captured facial image may be used to determine if the individual is wearing a face mask, and an electronic signal to admit the individual into the controlled area may be generated if the one or more configured computing devices determine that the individual is wearing the face mask.

In one embodiment, a method may include scheduling an appointment time for the individual to enter the controlled area, and linking the QR code to the scheduled appointment time. The stored facial record of the individual may also be linked with the QR code and/or the scheduled appointment time for the individual.

In one embodiment, the individual is denied admission into the controlled area if the captured QR code does not match the QR code transmitted to the individual.

In one embodiment, the individual is denied admission into the controlled area if the skin temperature reading obtained for the individual is outside the acceptable skin temperature range.

In one embodiment, the individual is denied admission into the controlled area if the captured facial image does not match the facial record of the individual that is stored in the facial recognition database.

In one embodiment, the individual is denied admission into the controlled area if the captured facial image indicates that the individual is not wearing a face mask.

In one embodiment, a QR code reader may be used for scanning the electronic device that is under the control of the individual for capturing the image of the transmitted QR code.

In one embodiment, a method may include transmitting the QR code to the individual in an electronic format that is adapted for being displayed on a visual display screen of the electronic device that is under the control of the individual.

In one embodiment, the one or more configured computing devices preferably operate one or more software programs that are configured for analyzing the captured facial image for confirming whether the individual is wearing the face mask.

In one embodiment, a method may include displaying a first visual image on a visual display screen of the one or more configured computing devices during the step of capturing the image of the QR code transmitted to the individual.

In one embodiment, a method may include displaying a second visual image on the visual display screen during the step of obtaining the skin temperature reading for the individual.

In one embodiment, a method may include displaying a third visual image on the visual display screen during the steps of capturing the facial image of the individual and determining if the individual is wearing the face mask.

In one embodiment, the first, second and third predetermined time periods have the same length or time duration (e.g., all time periods are 10 seconds in length).

In one embodiment, one or more or the first, second and third time periods may have a different duration (e.g., the first time period is 10 seconds in length, the second time period is 15 seconds in length, and the third time period is 12 seconds in length).

In one embodiment, the one or more configured computing devices automatically advance between displaying the first, second and third visual images without requiring the individual to physically touch any component of the one or more configured computer devices.

In one embodiment, a computer-implemented method of controlling access to a controlled area using a touchless experience preferably includes under control of one or more configured computing devices, storing a facial image of an individual in a facial recognition database, scheduling an appointment for the individual, generating a QR code that is linked with the individual, the stored facial image, and the scheduled appointment for the individual, and transmitting the QR code and information about the scheduled appointment to an electronic device that is under the control of the individual.

In one embodiment, the method may include, with the individual in the vicinity of the controlled area, capturing an image of the transmitted QR code from the electronic device that is under the control of the individual, and evaluating the captured QR code for determining whether the captured QR code matches the generated QR code that is linked to the individual.

In one embodiment, a method may include obtaining a skin temperature reading for the individual, and determining if the obtained skin temperature reading is within an acceptable temperature range.

In one embodiment, a method may include capturing a facial image of the individual, and analyzing the captured facial image for determining whether the captured facial image matches the facial record of the individual that is stored in the facial recognition database.

In one embodiment, a method may include analyzing the captured facial image for determining whether the individual is wearing a face mask.

In one embodiment, a method may include generating an electronic signal to admit the individual into the controlled area if the captured QR code matches the QR code transmitted to the individual and/or if the skin temperature reading obtained for the individual is within the acceptable skin temperature range and/or if the captured facial image matches the facial record of the individual that is stored in the facial recognition database and/or if the individual is wearing the face mask.

In one embodiment, a method may include denying admission of the individual into the controlled area if the individual seeks to access the controlled area outside a time range associated with the appointment.

In one embodiment, a method may include denying admission of the individual into the controlled area if the captured QR code does not match the QR code transmitted to the individual.

In one embodiment, a method may include denying admission of the individual into the controlled area if the skin temperature reading obtained for the individual is outside the acceptable skin temperature range.

In one embodiment, a method may include denying admission of the individual into the controlled area if the captured facial image does not match the facial record of the individual that is stored in the facial recognition database.

In one embodiment, a method may include denying admission of the individual into the controlled area if the captured facial image indicates that the individual is not wearing the face mask.

In one embodiment, a computer-implemented method of controlling access to a controlled area preferably includes before screening an individual for admittance into the controlled area, storing a facial image for the individual in a facial image database of a computer device.

In one embodiment, a method preferably includes assigning authenticating information to the individual, and transmitting the authenticating information to an electronic device that is under the control of the individual.

In one embodiment, a method preferably includes while screening the individual for admittance into the controlled area, scanning the electronic device that is under the control of the individual to retrieve the authenticating information for confirming the identity of the individual, capturing a new facial image of the individual, and obtaining a skin temperature reading for the individual.

In one embodiment, a method preferably includes generating a signal for authorizing admittance of the individual into the controlled area if the authenticating information retrieved from the electronic device matches the transmitted authenticating information and/or if the obtained skin temperature reading for the individual is within an acceptable temperature range and/or if the captured new facial image matches the stored facial image and/or if the captured new facial image confirms that the individual is wearing a protective face mask.

In one embodiment, an automated system for screening individuals preferably includes an access control reader including one or more computer devices configured for screening a pre-registered individual seeking admittance into a controlled area.

In one embodiment, the one or more computer devices contain a facial recognition database that stores a facial record for the pre-registered individual.

In one embodiment, a camera system is preferably configured to capture a facial image of the pre-registered individual, whereby the one or more computer devices evaluate the captured facial image for determining whether the captured facial image matches the facial record of the pre-registered individual that is stored in the facial recognition database.

In one embodiment, a computer-implemented system desirably includes a skin temperature sensor for obtaining a skin temperature reading for the pre-registered individual.

In one embodiment, one or more computer devices are preferably configured to generate an electronic signal to admit the pre-registered individual into the controlled area if 1) the captured facial image matches the facial record of the pre-registered individual that is stored in the facial recognition database, and 2) the skin temperature reading for the pre-registered individual is within an acceptable skin temperature range established for the automated system. If the pre-registered individual fails either test, then access is denied, and an alert message may be transmitted to security.

In one embodiment, a system may include an authenticating information generator that generates authenticating information that is used for confirming the identity of the pre-registered individual seeking admission to the controlled area.

In one embodiment, the authenticating information generator may be a QR code generator that is configured for transmitting a QR code to the pre-registered individual.

In one embodiment, an access control reader may include a QR code reader that is configured to scan the QR code that is transmitted to the pre-registered individual for confirming the identity of the individual.

In one embodiment, the QR code generator is desirably configured for transmitting the QR code to the pre-registered individual in an electronic format that is adapted for being displayed on an electronic device, such as a mobile phone.

In one embodiment, the QR code may be printed onto a paper sheet that is scanned using the access control reader.

In one embodiment, the one or more computer devices may operate software that is configured for analyzing the captured facial image for confirming whether the pre-registered individual is wearing a protective mask.

In one embodiment, the one or more computer devices authorize admission into the controlled area upon confirming that the pre-registered individual is wearing the protective mask.

In one embodiment, the one or more computer devices deny admission into the controlled area upon confirming that the pre-registered individual is not wearing the protective mask (i.e., a face mask).

In one embodiment, a camera system may include a first camera configured to capture a first facial image of the pre-registered individual within the visible light spectrum.

In one embodiment, the camera system may include a second camera configured to capture a second facial image of the pre-registered individual within the infrared light spectrum.

In one embodiment, the captured first and second facial images may be processed by the one or more computer devices for determining that the captured first and second facial images match the facial record of the pre-registered individual that is stored in the facial recognition database.

In one embodiment, a visitor management kiosk may contain the access control reader.

In one embodiment, a system may include a printer that is configured to print an admittance ticket or badge for the pre-registered individual after the pre-registered individual has been authorized for admission into the controlled area.

In one embodiment, the visitor management kiosk may include a stand and a ticket issuing slot may be formed in the stand for dispensing the admittance ticket or badge.

In one embodiment, the one or more computers may include a software protocol for transmitting an alert message to a host for notifying the host that the pre-registered individual has been authorized admission into the controlled area, or that the pre-registered individual has been denied admission into the controlled area.

In one embodiment, one or more computer devices may be utilized for operating software having various options.

Option #1. In one embodiment, a system takes inputs from cameras for users.

Option #2. In one embodiment, a system may speak to users and let them respond back to the system using a microphone.

Option #3. In one embodiment, a system may transform the entire experience to a user's mobile device (i.e., a cell phone; a smart phone) by simply using a QR code.

Option #4. In one embodiment, a system may include a throw away stylus that may be used to take inputs from the users.

Option #5. In one embodiment, a system may include hardware that enables an individual to use their legs for provide inputs and/or information to the system.

While we liked Option #s 1 and 2, Option #3 is widely used, but what about the investments made in screens? Option #s 4 and 5 were immediately rejected as that would mean an increase in costs. Option #4 in recurring costs, while Option #5 would increase the initial investment. Option #5 was also not favored because of the undesirable interfaces to adjust to the leg being used as an input, and because that would require using larger buttons or input fields so as to increase the accuracy of foot playing the role of the input instead of the hand.

In one embodiment, Option #s 1 and 2 are preferred because a device would only need to have a camera to be able to take things as an input or a speaker and a microphone. Most electronic devices today include most of this hardware.

In one embodiment, evaluations were conducted for devices incorporating Option #s 1 and 2. Most of the things played out well in both these options/methods. Google Talk, iPhone Siri, Alexa, and the like have a proven track record and worked well.

In one embodiment, evaluations were conducted on devices that did not have speakers and microphones in order to determine if the devices could still provide a touchless experience.

What if only a camera is available?

Based on these parameters, systems, devices, and methods were developed that use only screens and cameras or any other sensors or other non-touch devices as inputs from the users. No speakers or microphones were used.

There were many challenges including: 1) How to replace the “Cancel” button and “OK” buttons?—Solved; 2) How to replace the “Close” button in popups?—Solved; 3) How to show informational screens?—Solved; 4) How to show error screens?—Solved; 5) How to flow from one screen to the other?—Solved; 6) How to flow when there are errors in the input?—Solved; 7) How to answer multiple choice answers?—Solved; and 8) How to answer messages that need user to write anything?—Solved.

If the inputs were coming through cameras, then what kind of inputs could be drawn from the camera which were simple to use without any great learning curve on the user? So, the question is what kind of inputs can be taken from the camera?

These inputs may include 1) Photos; 2) Mask detection; 3) Face recognition; 4) Temperature (i.e., body temperature); 5) Gestures (e.g., face movements, finger movements, hand movements, eye movements, and/or head movements); and 6) QR code-based or barcode-based inputs.

Based upon the above, methods were developed to use all of the different input types to create a system to interact with a user using only one or more cameras. The details of which are mentioned in the summary.

In one embodiment, the system uses input from a camera along with the methods and their embodiments which are responding to camera inputs. The screens work on their own, as well.

In one embodiment of the normal or happy flow, the user input may not be required only on a certain number of screens in the flow (e.g., informational screens, followed by user input screens, followed by welcome screens).

In one embodiment of the normal or happy flow, the user input screens, and informational screens may be alternating (e.g., informational screen for next step, input screen, informational screen for next step, input screen). In one embodiment, the input and informational screens may be in any sequence as desired.

In one embodiment, in the event of an error, a user may be provided with multiple opportunities to stay on the same screen for input after the error screen, before retiring the flow to the next user (e.g., “The system could not detect the mask. Please wear a mask and try again.”). In one embodiment, if after two times the mask is not detected, then the screen may provide another error message such as “We cannot allow you into the premises without wearing a mask. We are sorry about the inconvenience.”), and the system may then return back to the start of the process for the next user.

In one embodiment of the system, in one method, since the screen is expecting a user input, a situation may arise whereby no user is present. In these instances (e.g., no user present), the system may include a no action performed flow. In this method, if the user does not give the user input, the system is configured to a no-action performed flow (e.g., after the information screen, the system is waiting for the user to scan a QR code or barcode, but the user is not there to perform any action.) In such cases, the screen flow has a no-action performed flow which gets activated. In this case, the no-action flow would preferably return to the informational flow screen, which is the beginning of the flow.

In one embodiment, it may also happen that the user may abandon the flow. Also, in these cases, the no-action flow is picked up (e.g., the user (or a by-passer) may be in the middle of the screen flow like on a detecting mask screen, but may just move away due to the user realizing that his or her mask is in the car, due to an incoming telephone call, or some other reason that the user may want to attend to and for which the user cannot keep the queue waiting.) In this case also, the no flow action would be activated and would preferably return to the informational flow screen, which is the beginning of the flow.

In one embodiment, the systems, devices and methods disclosed herein may include the use of cameras or smart cameras (e.g., for mask detection, for face recognition, for taking photographs), the use of sensors (e.g., for temperature detection, proximity sensors, NFC), the use of readers (e.g., access card readers, QR code readers, barcode readers), or the use of physical gestures (e.g., hand gestures, eye movements, finger gestures, head gestures), or the use of printers, scanners, automated doors, tags, the users' device, or any other system or electronic device, which enhances the no touch experience for the user.

These and other preferred embodiments of the present patent application will be described in more detail herein.

### BRIEF DESCRIPTION OF THE DRAWINGS

FIG. 1 is a flow chart showing a method of using timers for normal/happy flows, error/alternate/exception flows and no-action flows used in controlling access to a physical space including monitoring the body temperature and personal protective equipment status of individuals, in accordance with one embodiment of the present patent application.

FIG. 2 is a flow table showing the normal flow, error flow, and no-action flow for the flow chart shown in FIG. 1.

FIG. 3 is a screen shot that is displayed by a system that operates the flow chart and the screen flow table shown in respective FIGS. 1 and 2, in accordance with one embodiment of the present patent application.

FIG. 4 is another screen shot that is displayed by a system that operates the flow chart and the screen flow table shown in respective FIGS. 1 and 2, in accordance with one embodiment of the present patent application.

FIG. 5 is another screen shot that is displayed by a system that operates the flow chart and the screen flow table shown in respective FIGS. 1 and 2, in accordance with one embodiment of the present patent application.

FIG. 6 is another screen shot that is displayed by a system that operates the flow chart and the screen flow table shown in respective FIGS. 1 and 2, in accordance with one embodiment of the present patent application.

FIG. 7 is another screen shot that is displayed by a system that operates the flow chart and the screen flow table shown in respective FIGS. 1 and 2, in accordance with one embodiment of the present patent application.

FIG. 8 is another screen shot that is displayed by a system that operates the flow chart and the screen flow table shown in respective FIGS. 1 and 2, in accordance with one embodiment of the present patent application.

FIG. 9 is another screen shot that is displayed by a system that operates the flow chart and the screen flow table shown in respective FIGS. 1 and 2, in accordance with one embodiment of the present patent application.

FIG. 10 is another screen shot that is displayed by a system that operates the flow chart and the screen flow table shown in respective FIGS. 1 and 2, in accordance with one embodiment of the present patent application.

FIG. 11 is another screen shot that is displayed by a system that operates the flow chart and the screen flow table shown in respective FIGS. 1 and 2, in accordance with one embodiment of the present patent application.

FIG. 12 is another screen shot that is displayed by a system that operates the flow chart and the screen flow table shown in respective FIGS. 1 and 2, in accordance with one embodiment of the present patent application.

FIG. 13 is another screen shot that is displayed by a system that operates the flow chart and the screen flow table shown in respective FIGS. 1 and 2, in accordance with one embodiment of the present patent application.

FIG. 14 is another screen shot that is displayed by a system that operates the flow chart and the screen flow table shown in respective FIGS. 1 and 2, in accordance with one embodiment of the present patent application.

### DETAILED DESCRIPTION OF PREFERRED EMBODIMENTS

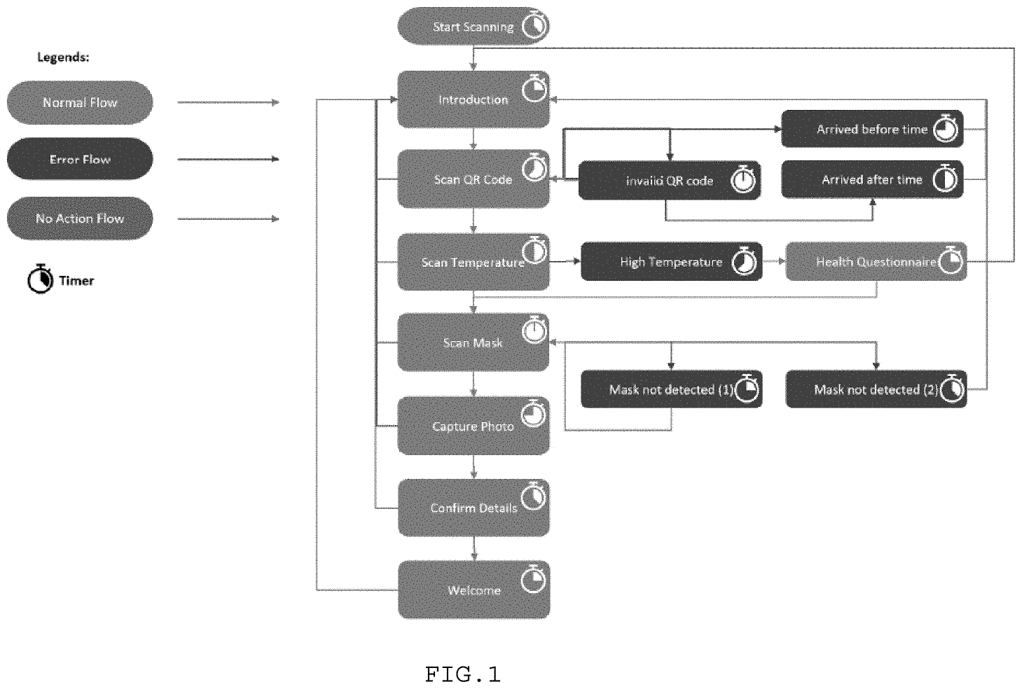

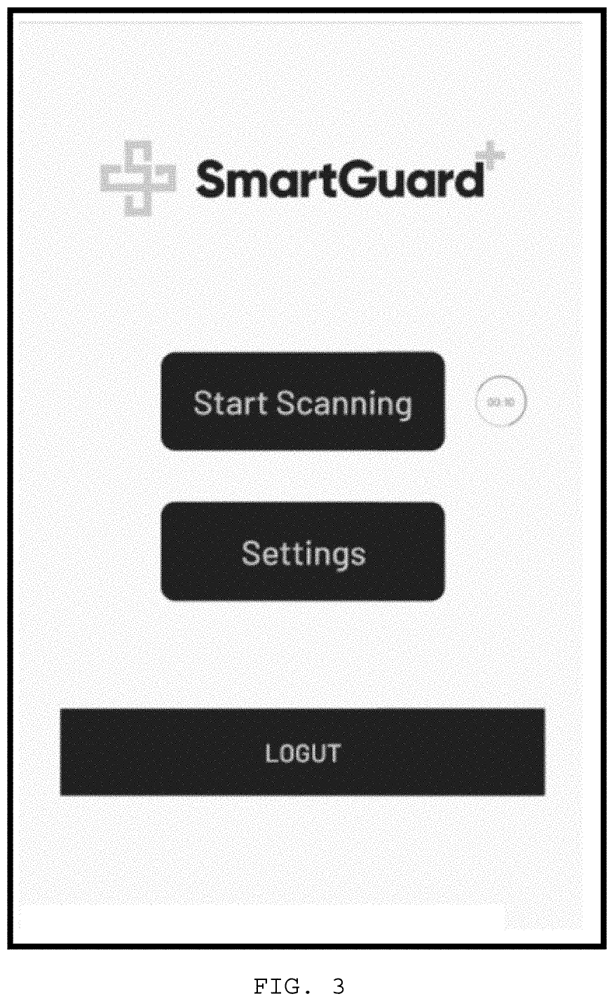

Referring to FIG. 1, in one embodiment, a screen flow chart links Normal Flows, Error Flows, and No Action Flows with timers. The flow chart shows the green arrows and green steps as the Normal Flows, the red arrows and red steps as the Error Flows or alternate flows, and the blue arrows show the No Action Flows of the system. The timer on each screen shows how much time remains until the system proceeds to the next screen. In the embodiment shown in FIG. 1, the final screen loops back to the first screen (i.e., the Introduction Screen shown in FIG. 3) so that the next user may utilize the system to commence a touchless experience.

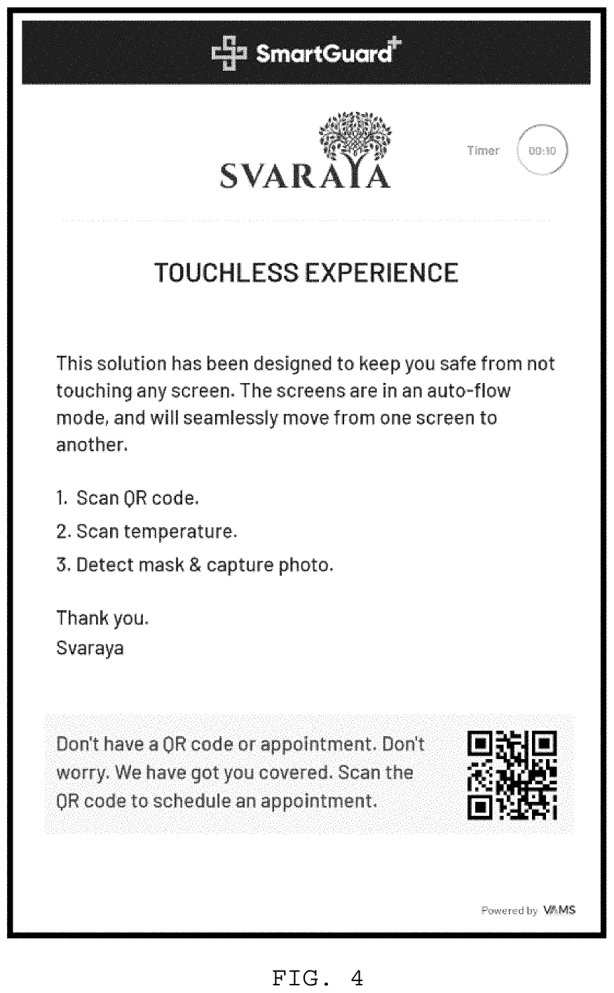

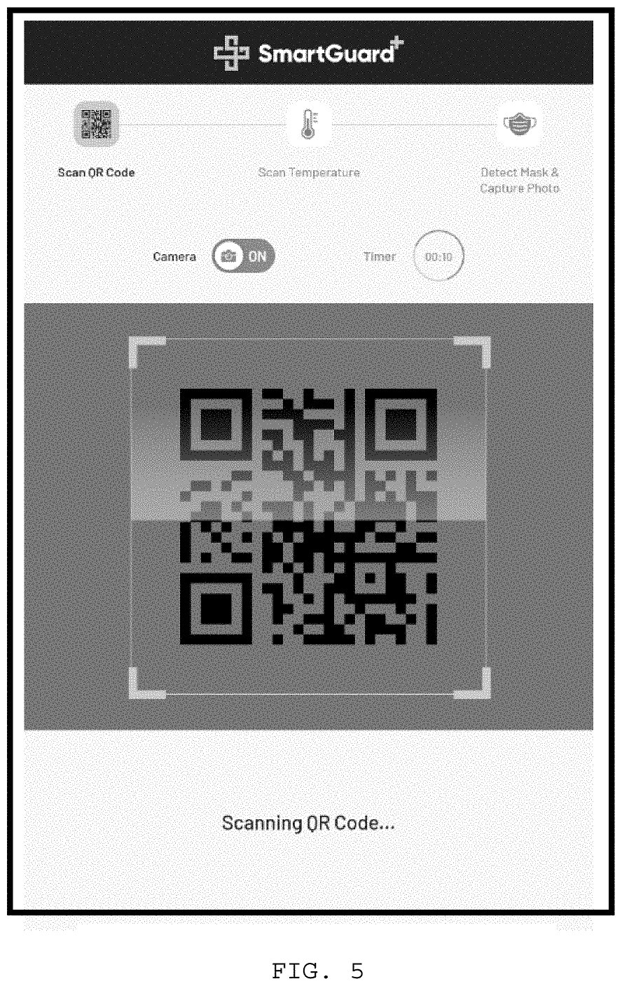

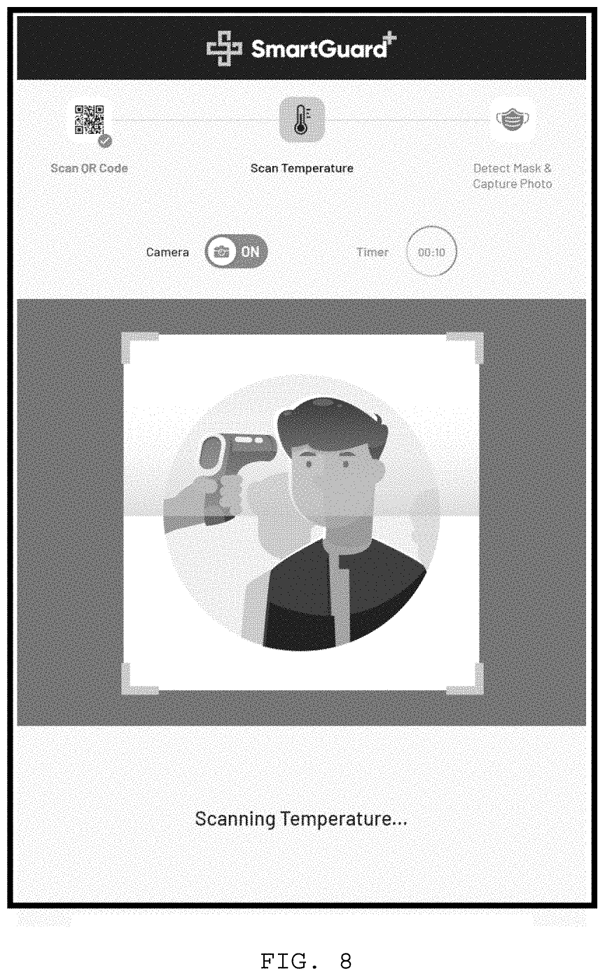

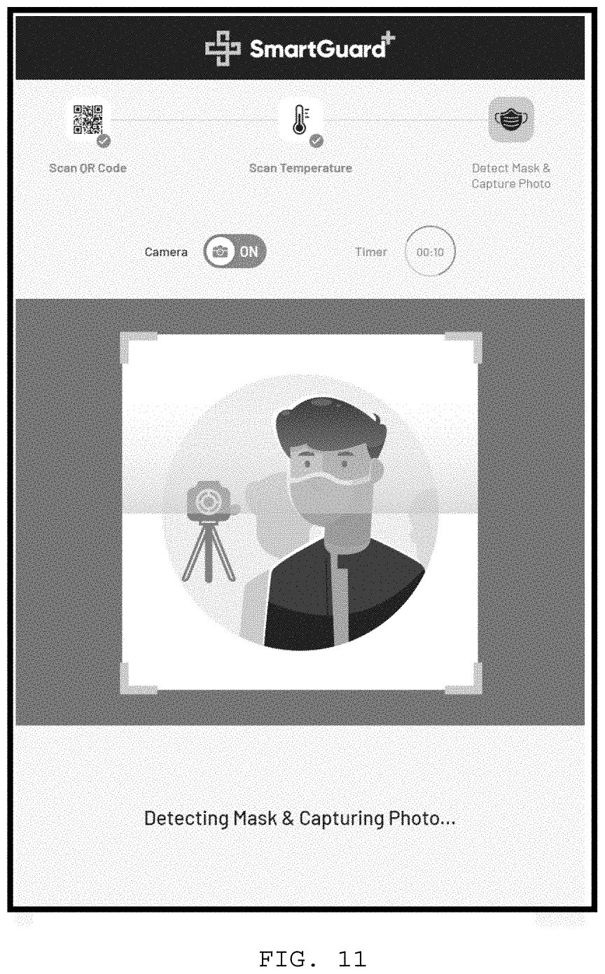

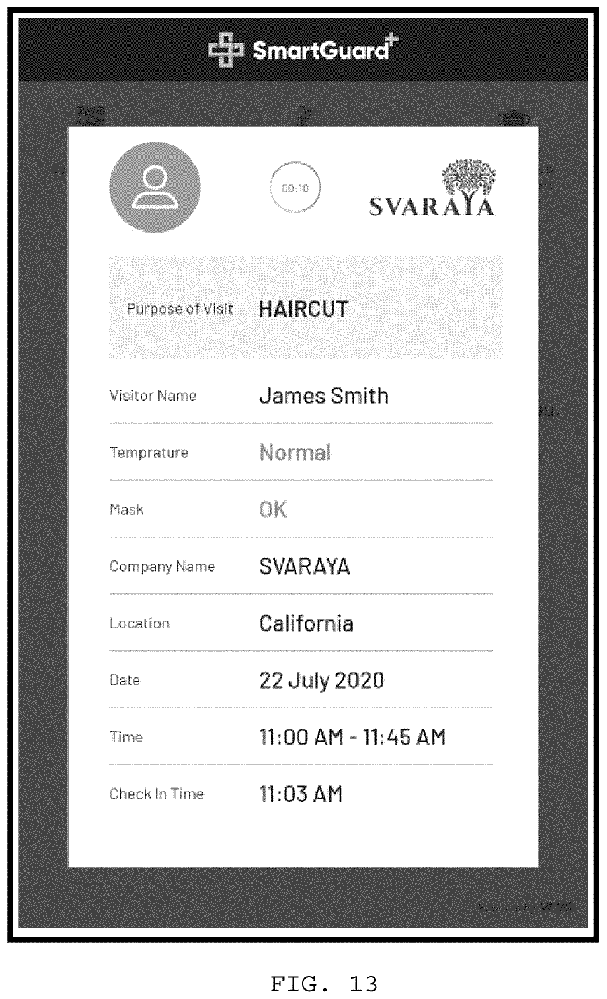

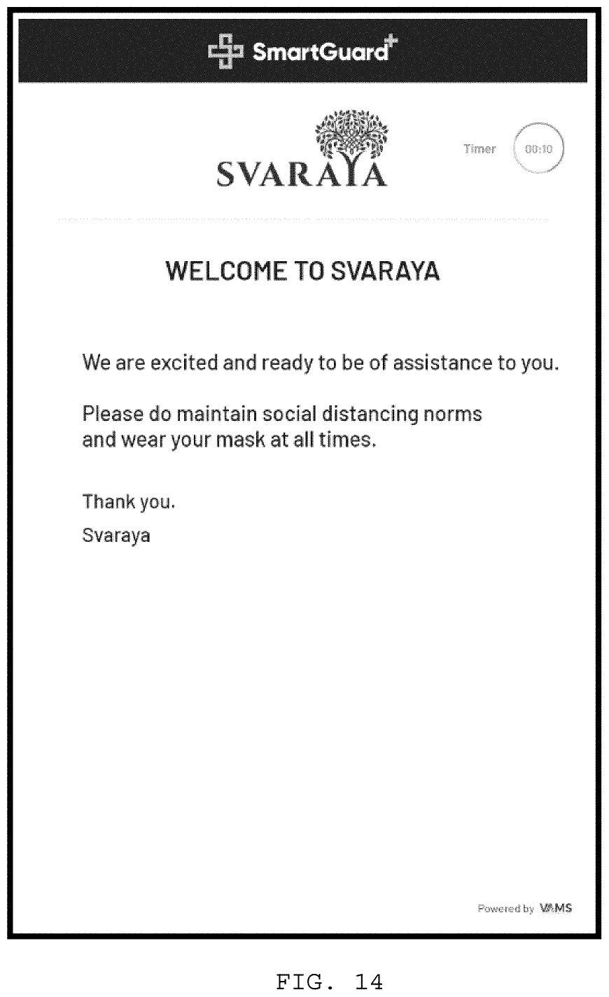

In one embodiment, when proceeding through the Normal Flow steps, a system will preferably display the following screens in the following order: 1) a Start Scanning screen (FIG. 3) that commences the authentication/screening process for the user; 2) an Introduction screen (FIG. 4) that displays an introductory message for a user; 3) a Scan QR Code screen (FIG. 5) during which the user's QR Code will be scanned; 4) a Scan Temperature screen (FIG. 8) during which the user's temperature will be scanned; 5) a Scan Mask Screen (FIG. 11) during which the system will determine if the user is wearing a face mask; 6) a Capture Photo screen (FIG. 11) during which a photograph of the user will be captured by the system and which may be compared to a photograph that has been previously filed with the system; 7) a Confirm Details screen (FIG. 13) that will display the appointment details for the user; and 8) a Welcome screen (FIG. 14) that displays a welcome message for the user.

In one embodiment, if the user successfully proceeds through the Normal Flow steps with no errors and no inaction by the user, then the user will be fully authenticated and may proceed to the next stage, such as being granted access into a building and/or a controlled area (e.g., a secure laboratory).

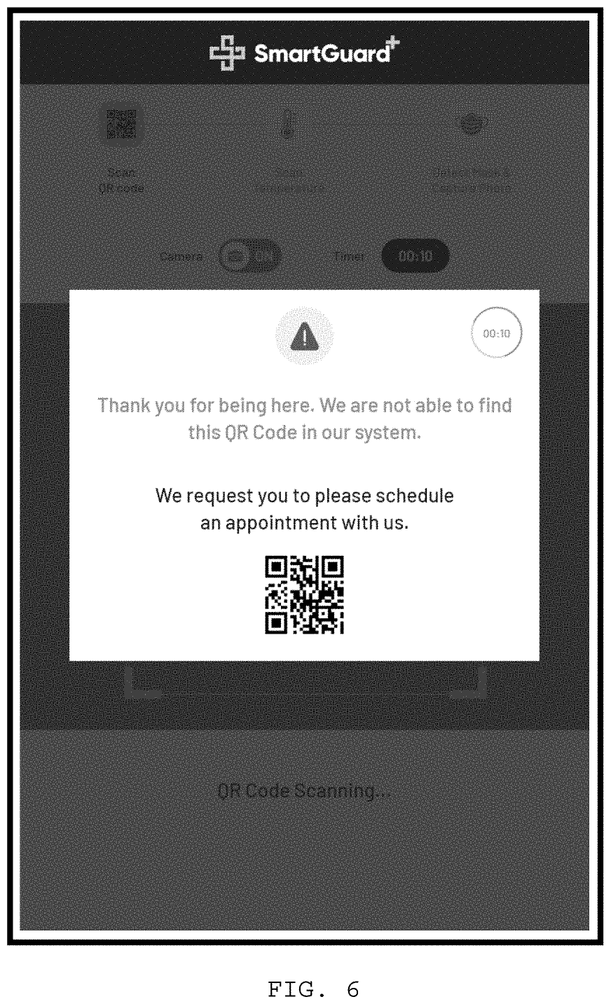

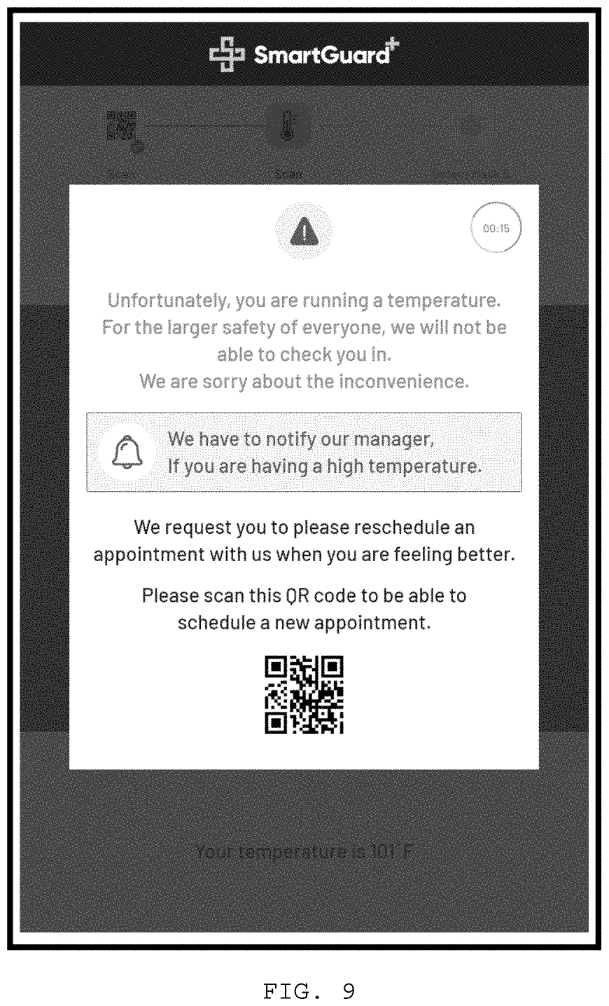

In one embodiment, as a user proceeds through the Normal Flow steps, the system may detect an error or a deficiency, which will direct the user into one or more Error Flow branches of the software. In one embodiment, a user will not be authenticated and/or granted access if the user remains in the Error Flow branch. A user may be directed into the Error Flow if any one of the following events occurs: 1) the user has arrived too early for a scheduled appointment; 2) the user presents an invalid QR code (FIG. 6); 3) the user has arrived too late for a scheduled appointment; 4) the user has been detected as having a high temperature that is above a normal temperature range (FIG. 9); 5) the user has been detected as not wearing a face mask a first time; and 6) the user has been detected as not wearing a face mask a second time (after being detected as not wearing a face mask the first time).

In one embodiment, a user may be directed into the Error Flow branch if the user has arrived on time for an appointment, but has been placed in queue (i.e., placed in line to wait for an appointment).

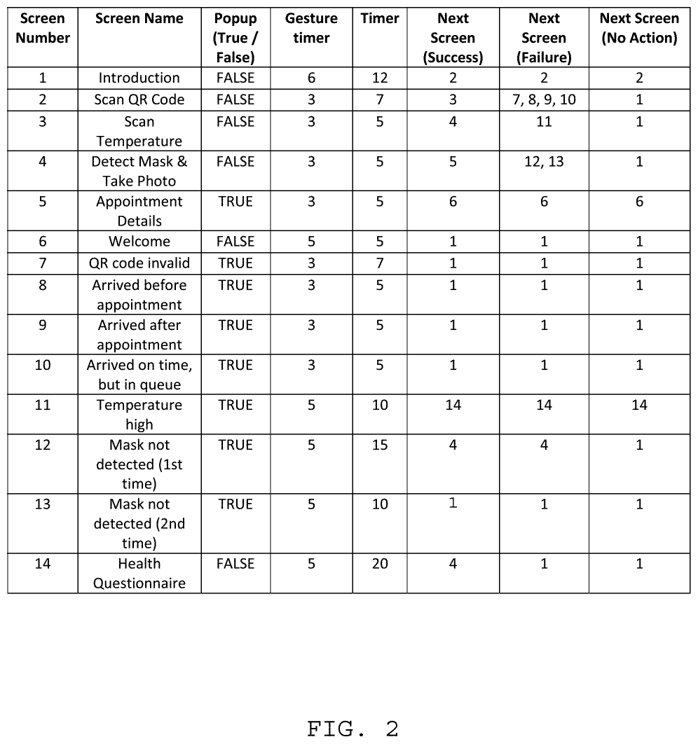

FIG. 2 is a screen flow table that shows the linkage between the Normal Flows, Error Flows, and No Action Flows with timers and gesture (forward or rewind) timers. The table further indicates if the screen that is being displayed is a normal screen or a pop-up screen. In one embodiment, a pop-up screen may be displayed if a user fails to successfully complete one of the steps in the Normal Flow process or if a user is directed into the Error Flow. The table in FIG. 2 has more error flows than the one represented in FIG. 1. The chart (FIG. 1) and the table (FIG. 2) together show one of the ways in which the system may be used.

Referring to FIG. 2, in one embodiment, when a user approaches a component of a system (e.g., a kiosk) for being authenticated and/or gaining access, the user will preferably see an Introduction screen (i.e., Screen Number 1). In one embodiment, after 12 seconds of time has passed, the system will automatically proceed to displaying the Scan QR Code screen (i.e., Screen Number 2). The user may shorten the time for advancing from Screen Number 1 to Screen Number 2 by making a physical gesture (e.g., waving a hand from left to right in front of a camera or sensor). In one embodiment, each distinct physical gesture will shorten the waiting time for proceeding from Screen Number 1 to Screen Number 2 by six (6) seconds. In one embodiment, a sweep of the hand from right to left will lengthen and/or add six more seconds of time to how long Screen Number 1 is displayed before the system advances to displaying Screen Number 2.

In one embodiment, if the Scan QR Code step is a success (i.e., Normal Flow), the program proceeds to Screen Number 3 (i.e., Scan Temperature). If the Scan QR Code step is a failure (i.e., Error Flow), the program proceeds to one of Screen Number 7 (i.e., QR code invalid), Screen Number 8 (i.e., Arrived before appointment), Screen Number 9 (i.e., Arrived after appointment), or Screen Number 10 (i.e., Arrived on time, but in queue).

In one embodiment, if the Scan Temperature step is a success (i.e., Normal Flow), the program proceeds to Screen Number 4 (i.e., Detect Mask & Take Photo). If the Scan Temperature step is a failure (i.e., Error Flow), the program proceeds to Screen Number 11 (i.e., the pop-up Temperature high screen shown in FIG. 9), and then to Screen Number 14 (i.e., Health Questionnaire).

In one embodiment, if the Detect Mask & Take Photo step is a success (i.e., Normal Flow), the program proceeds to Screen Number 5 (i.e., Appointment Details), and then to Screen Number 6 (i.e., Welcome screen). If the Detect Mask & Take Photo step is a failure (i.e., Error Flow), the program proceeds to Screen Number 12 (i.e., Mask not detected (1^{st} time)). If the user then properly dons and displays that he or she is wearing a face mask, the system will proceed to Screen Number 5 (i.e., Appointment Details). If the Detect Mask & Take Photo step is a failure a second time, the program proceeds to Screen Number 13 (i.e., Mask not detected (2^{nd} time)). After the user fails to wear the face mask the second time, the program will return to Screen Number 1 (i.e., the Introduction screen) to that the system may process the next user.

For the flow chart, table and programs shown and described in FIGS. 1 and 2, a user may shorten the time for moving from one display screen to the next display screen by making a physical gesture (e.g., a sweep of a hand from left to right in front of a camera or sensor). In one embodiment, the time that will elapse before the program proceeds to the next display screen may be shortened for each physical gesture. For example, a physical gesture may reduce the waiting time by three seconds, five seconds, six seconds, or any time period selected by a programmer and/or system operator. Thus, a user may interact with the system to decrease the length of time that a screen is displayed without physically touching any of the components of the system.

In one embodiment, a user may rapidly move past a display screen by making one or more physical gestures. For example, the Introduction Screen (i.e., Screen Number 1) may be displayed for 12 seconds, and a user may rapidly proceed to Screen Number 2 (i.e., Scan QR Code), without waiting for 12 seconds, by making two physical gestures is relatively rapid succession (e.g., a sweep of a hand from left to right in front of a camera), with the first physical gesture reducing the waiting time by six seconds and the second physical gesture reducing the waiting time by an additional six seconds.

In one embodiment, the time that will elapse before the program proceeds to the next display screen may be increased for each physical gesture (e.g., a sweep of the hand from right to left in front of a camera or a sensor). For example, a physical gesture may increase the waiting time by three seconds, five seconds, six seconds, or any time period selected by a programmer and/or system operator. Thus, a user may interact with the system to increase the length of time that a screen is displayed without physically touching any of the components of the system.

FIGS. 3-14 show different screenshots with timers defined in the screen flow chart (FIG. 1) and the screen flow table (FIG. 2), in accordance with one embodiment of the present patent application. Each screen, whether a popup or not, has a timer on it, which helps the user to navigate through the touchless experience. The user may use a gesture (e.g., a hand sweep in front of a camera or a sensor) to fast forward or rewind the timer.

Referring to FIG. 3, in one embodiment, a screen may include a button that is set as a default, after which the timer runs down, which will forward to the next screen. If the user wishes to change the settings and/or options, the user may use a gesture (e.g., a hand sweep) to change the choice.

Referring to FIG. 4, in one embodiment, the system includes a screen (i.e., Screen Number 1 in FIG. 2) whereby the user is introduced to the touchless experience with a rundown timer. The screen auto-forwards to the next screen in the flow after the timer runs down. In one embodiment, the timer on this first screen in the flow may start only when the user is detected.

Referring to FIG. 5, in one embodiment, the system may include a screen (i.e., Screen Number 2 in FIG. 2) that requests the user to show a QR code and the user displays the QR code in the camera. If the user is not there to show the QR code or abandons the QR code process, then the no-action flow is activated and the screen flows back to the introduction screen (i.e., FIG. 4; Screen Number 1 in FIG. 2), in accordance with one embodiment of the present patent application. If the user shows the QR code, then the system captures and/or records the QR code and processes it.

Referring to FIG. 6, in one embodiment, if the QR code provided by the user does not exist in the system (e.g., stored in memory or a database), an error flow is activated, and an error popup is shown with a timer. Once the timer is run down, based up the success, or error, or no-action flow, the system flows and/or advances to the next screen.

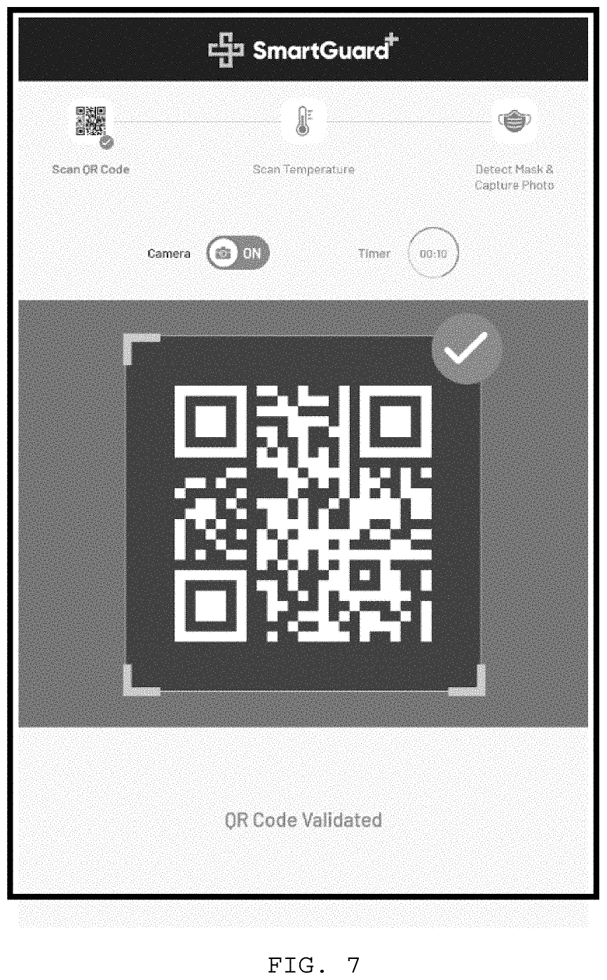

Referring to FIG. 7, in one embodiment, if the QR code provided by the user exists in the system and passes all of the valid conditions to reach a success flow, the screen automatically forwards to the next screen without waiting for the timer to run down.

Referring to FIG. 8, in one embodiment, the system preferably includes a display screen whereby the user is requested to scan their temperature and the user stands in front of a camera to be able to obtain the user's body temperature. If the user abandons the temperature scanning process, then the no-action flow is activated and the screen flows to back to the introduction screen (FIG. 4; Screen Number 1 in FIG. 2). If the user stands in front of the camera and the temperature is recorded, then the system takes the user's body temperature and processes it.

Referring to FIG. 9, in one embodiment, the system displays a screen when the user's recorded body temperature is above permissible limits. When a high body temperature is recorded (e.g., fever level; above permissible limits), the system's error flow is activated, and an error popup is shown with a timer. Once the timer is run down, based on the success or error or no-action flow, the system flows to the next screen configured. If the user's temperature is too high, the user is preferably directed to complete a Health Questionnaire (i.e., Screen Number 14 in FIG. 2).

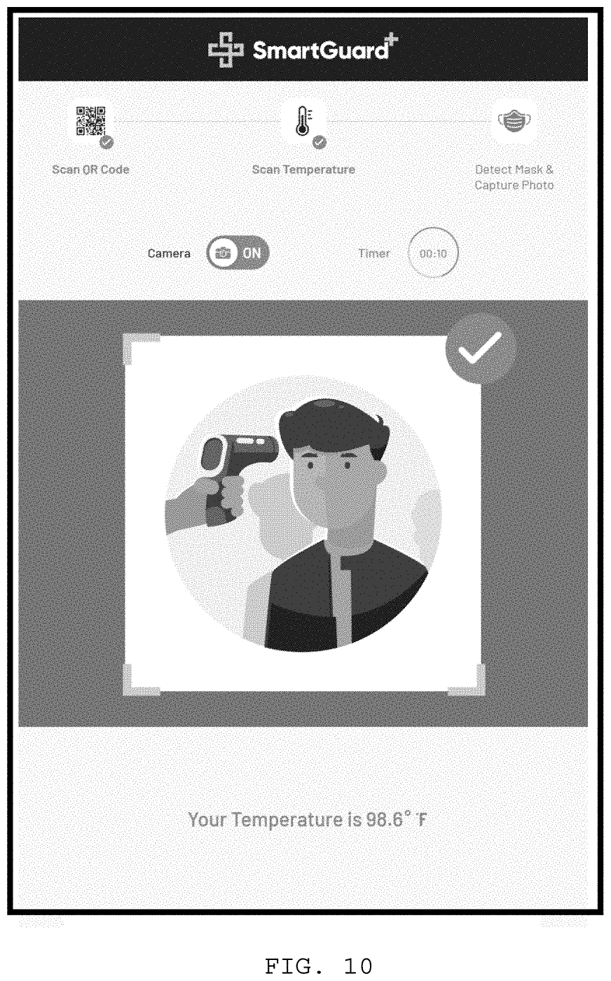

Referring to FIG. 10, in one embodiment, the system preferably includes a display screen where the user's recorded temperature is permissible and reaches the Normal/success flow. Once the Normal flow is completed, the system automatically forwards to the next display screen of the Normal/success flow, without waiting for the timer to run down.

Referring to FIG. 11, in one embodiment, the system may attempt to detect whether the user is wearing a protective mask, a face mask, or a face covering. In one embodiment, the system preferably captures a photo of the user as the user stands in front of a camera to confirm that the user is wearing a mask. If the user abandons the process, then the no-action flow is activated and the screen flows to back to the introduction screen (FIG. 4). If the user stands in front of the camera and the mask is detected and the user's face is completely visible, then the system records the photograph of the user and processes the information.

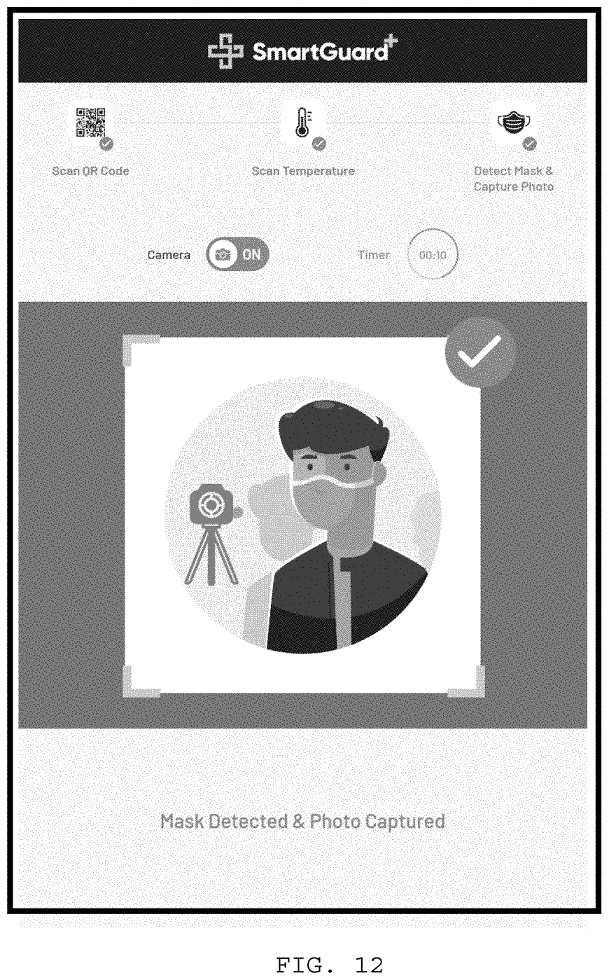

Referring to FIG. 12, in one embodiment, the system may include a screen that indicates that the user's mask has been detected and the photo is captured from the user and reaches the success flow. Once the Normal/success flow is completed, the system automatically advances to the next screen of the Normal/success flow, without waiting for the timer to run down (i.e., expire).

Referring to FIG. 13, in one embodiment, the system preferably includes a display screen that displays the details of the appointment that has been scheduled and the information is displayed to the user. Once the timer runs down, the system automatically forwards to the next screen of the Normal/success flow. In one embodiment, the system may print a badge for the user.

Referring to FIG. 14, in one embodiment, the system preferably includes a display screen that displays a welcome message to the user. The Welcome screen preferably includes a rundown timer. The system preferably auto-forwards to the next screen in the flow after the timer runs down. This will take the system back to the introduction screen (FIG. 4), where the next user may commence an authentication and access process.

In one embodiment, systems, devices, and methods for controlling access to controlled areas (e.g., buildings; physical spaces) provide users with touchless or hands-free methodologies that are useful in a post-COVID era. The systems, devices, and methods may use a camera for recording and obtaining all input required from a user. In one embodiment, the system manages a single or multi-screen flow based upon each of the user's inputs. Based upon each input from the user, the system flows to the next screen, stays on the same screen, or moves to a previous screen. Based upon the input received from the user, the system has a central processing unit or artificial intelligence that processes Normal/success flows, Error flows and No Action performed flows. Each screen or pop-up in the system includes self-destruct timers, which can be configured independently for each screen or pop-up. The timer removes the need for the user to click or physically contact on any button or a screen to continue forward or go back. After each timer has expired, the system moves seamlessly to the next screen in the flow set up. If the action is performed quicker than the time provided, then the screen moves quickly to the next screen without having the user wait for the timer to expire. The same process can run endlessly in a loop for every user.

In one embodiment, systems, devices, and methods may include one or more of the systems, devices and methods disclosed in U.S. patent application Ser. No. 17/216,320, filed on Mar. 29, 2021, the disclosure of which is hereby incorporated by reference herein.

In one embodiment, a system may include an access control reader that is preferably utilized to authenticate individuals and control access to controlled areas including but not limited to enclosed physical locations, research laboratories, manufacturing facilities, prisons, military installations, or factory floors. In one embodiment, the access control reader is desirably in communication with and is controlled by a central controller (e.g., a computer network) that may include one or more servers, one or more central processing units (CPUs), software, computer applications, video monitors, and computer monitors. The access control system may incorporate wired or wireless communication networks. In one embodiment, the system controller may be used for establishing rules that are used to authenticate individuals and control and monitor access to controlled areas. In one embodiment, the access control reader may operate standalone (e.g., without the system controller) and may be directly wired to both input and output peripheral electronic devices including but not limited to a keypad/card reader, an alarm, an electric door lock, a door/ajar sensor, an exit switch, or a surveillance camera.

As used herein, a central processing unit (CPU), also called a central processor, main processor or just a processor, is the electronic circuitry that executes instructions comprising a computer program. The CPU performs basic arithmetic, logic, controlling, and input/output operations specified by the instructions in the program.

In one embodiment, an operator of an access control system may modify the number of rules that must be satisfied prior to authorizing an individual to have access to a controlled area. For example, gaining access to a nuclear site may require more rules to be satisfied, and gaining access to an office building may require fewer rules to be satisfied.

In one embodiment, the access control system preferably includes a keypad/card reader that is coupled with the access control reader via a communication line. The keypad/card reader may be configured to detect the presence of various types of hand-held cards that are used for gaining access to secured locations including but not limited to identification cards, building access cards, credit cards, and debit cards. In one embodiment, the communication line between the card reader and the access control reader may incorporate various communication protocols including but not limited to the Wiegand communication protocol and/or the Open Supervised Device Protocol (OSDP). The keypad/card reader represents only one of many different authentication technologies which can be used with the embodiment. Other authentication technologies may include Barcode, Mag Stripe, Bluetooth, Near-field communication (NFC), Ultrawide band (UWB), Ultra high frequency (UHF), Zigbee, Zwave, and artificial intelligence voice responders including Amazon Alexa, Apple Siri, and Google Assistant.

In one embodiment, an access control system preferably includes an alarm that may be activated if the system determines that an individual attempting to gain access to a controlled area fails one or more of the rules that have been established via the central control unit. For example, if the access control reader detects that an individual attempting to gain access to a secure area has an unacceptable skin temperature (e.g., 103 degrees Fahrenheit), the access control reader will send a signal to the alarm to activate the alarm. In one embodiment, the alarm may generate a visible alarm (e.g., flashing light) and/or an audible alarm (e.g., a loud, piercing siren sound).

In one embodiment, an access control system may be coupled with a security component that is normally locked for preventing access to a controlled area, and that is unlocked to allow access to the controlled area. In one embodiment, the security component may be a door having an electric lock that is in communication with the access control reader. In one embodiment, if an individual engaging with the access control reader satisfies the rules that have been established for being granted access to a controlled area, the access control reader will transmit a signal to the electric lock on the door for moving the electric lock to an open/unlocked position so that the door may be opened. The access control system may also be used to open and close a gate or a turnstile.

In one embodiment, an access control system preferably includes a door status sensor that periodically senses and/or detects whether the door is open or closed/locked. In one embodiment, if the door remains open after a predetermined time (e.g., 30 seconds), the access control reader will recognize that the door is open and will send an alarm signal to the alarm.

While the foregoing is directed to embodiments of the present invention, other and further embodiments of the invention may be devised without departing from the basic scope thereof, which is only limited by the scope of the claims that follow. For example, the present invention contemplates that any of the features shown in any of the embodiments described herein, or incorporated by reference herein, may be incorporated with any of the features shown in any of the other embodiments described herein, or incorporated by reference herein, and still fall within the scope of the present invention.

What is claimed is:

1. A computer-implemented method of controlling access to a controlled area using a touchless experience comprising:
under control of one or more configured computing devices, generating a QR code that is linked with an individual;
transmitting the QR code to an electronic device that is under the control of the individual;
capturing an image of the QR code transmitted to the electronic device that is under the control of the individual, wherein said one or more configured computing devices evaluate the captured QR code for determining whether the captured QR code matches the QR code transmitted to the electronic device that is under the control of the individual;
obtaining a skin temperature reading for the individual;
capturing a facial image of the individual, wherein said one or more configured computing devices evaluate the captured facial image for determining whether the individual is wearing a face mask;
generating an electronic signal to admit the individual into said controlled area if the captured QR code matches the QR code transmitted to the individual, if the skin temperature reading obtained for the individual is within an acceptable skin temperature range, and if the captured facial image indicates that the individual is wearing the face mask.

2. The method as claimed in claim 1, further comprising:
scheduling an appointment time for the individual to enter said controlled area;
linking the QR code to the scheduled appointment time.

3. The method as claimed in claim 1, further comprising denying admission of the individual into said controlled area if the captured QR code does not match the QR code transmitted to the individual.

4. The method as claimed in claim 1, further comprising denying admission of the individual into said controlled area if the captured facial image does not match a facial record of the individual that is stored in a facial recognition database.

5. The method as claimed in claim 1, further comprising denying admission of the individual into said controlled area if the skin temperature reading obtained for the individual is outside the acceptable skin temperature range.

6. The method as claimed in claim 1, further comprising using a QR code reader for scanning the electronic device that is under the control of the individual for capturing the image of the transmitted QR code.

7. The method as claimed in claim 1, further comprising transmitting the QR code to the individual in an electronic format that is adapted for being displayed on a visual display screen of the electronic device that is under the control of the individual.

8. The method as claimed in claim 1, wherein said one or more configured computing devices operate software that is configured for analyzing the captured facial image for confirming whether the individual is wearing the face mask.

9. The method as claimed in claim 1, further comprising:
displaying a first visual image on a visual display screen of said one or more configured computing devices during the step of capturing the image of the QR code transmitted to the individual;
displaying a second visual image on said visual display screen during the step of obtaining the skin temperature reading for the individual; and
displaying a third visual image on said visual display screen during the steps of capturing the facial image of the individual and determining if the individual is wearing the face mask.

10. The method as claimed in claim 9, further comprising using one or more timers for controlling how long the first, second and third visual images are displayed on said visual display screen, wherein the one or more timers are different for different flows including normal flow, error flow, no action flow, or a combination of any or all three flows.

11. The method as claimed in claim 10, further comprising using one or more physical gestures for lengthening or shortening how long one or more of the first, second and third visual images are displayed on said visual display screen.

12. The method as claimed in claim 11, further comprising sweeping a hand from left to right in front of a camera for shortening how long one or more of the first, second and third visual images are displayed on said visual display screen.

13. The method as claimed in claim 11, further comprising sweeping a hand from right to left in front of a camera for lengthening how long one or more of the first, second and third visual images are displayed on said visual display screen.

14. The method as claimed in claim 11, wherein in response to the one or more physical gestures said one or more configured computing devices advance between displaying the first, second and third visual images without requiring the individual to physically touch any component of said one or more configured computer devices for providing a touchless experience.

15. A computer-implemented method of controlling access to a controlled area using a touchless experience comprising:
under control of one or more configured computing devices, scheduling an appointment for the individual;
generating a QR code that is linked with the individual and the scheduled appointment for the individual;
transmitting the QR code and information about the scheduled appointment to an electronic device that is under the control of the individual;
with the individual in the vicinity of said controlled area, capturing an image of the transmitted QR code from the electronic device that is under the control of the individual;
evaluating the captured QR code for determining whether the captured QR code matches the generated QR code that is linked to the individual;
obtaining a skin temperature reading for the individual;
determining if the obtained skin temperature reading is within an acceptable temperature range;
capturing a facial image of the individual;
analyzing the captured facial image for determining whether the individual is wearing a face mask;
generating an electronic signal to admit the individual into said controlled area if the captured QR code matches the QR code transmitted to the individual, if the skin temperature reading obtained for the individual is within the acceptable skin temperature range, and if the individual is wearing the face mask.

16. The method as claimed in claim 15, further comprising:
denying admission of the individual into said controlled area if the individual seeks to access said controlled area outside a time range associated with the appointment; or
denying admission of the individual into said controlled area if the captured QR code does not match the QR code transmitted to the individual; or
denying admission of the individual into said controlled area if the skin temperature reading obtained for the individual is outside the acceptable skin temperature range; or
denying admission of the individual into said controlled area if the captured facial image indicates that the individual is not wearing the face mask.

17. The method as claimed in claim 15, further comprising:
displaying a first visual image on a visual display screen during the step of capturing the image of the QR code transmitted to the individual;
displaying a second visual image on said visual display screen during the step of obtaining the skin temperature reading for the individual;
displaying a third visual image on said visual display screen during the steps of capturing the facial image of the individual for determining if the individual is wearing the face mask;
using one or more timers for controlling how long the first, second and third visual images are displayed on said visual display screen, wherein said one or more configured computing devices are programmed for automatically advancing from displaying the first visual image to displaying the second visual image after a first predetermined time period that is monitored by said one or more timers, and wherein said one or more configured computing devices are programmed for automatically advancing from displaying the second visual image to displaying the third visual image after a second predetermined time period that is monitored by said one or more timers.

18. The method as claimed in claim 17, further comprising using one or more physical gestures for lengthening or shortening how long one or more of the first, second and third visual images are displayed on said visual display screen.

19. The method as claimed in claim 18, further comprising:
sweeping a hand from left to right in front of a camera for shortening how long one or more of the first, second and third visual images are displayed on said visual display screen; and
sweeping a hand from right to left in front of a camera for lengthening how long one or more of the first, second and third visual images are displayed on said visual display screen.

20. A computer-implemented method of controlling access to a controlled area, the method comprising:
before screening an individual for admittance into said controlled area, assigning authenticating information to the individual;
transmitting the authenticating information to an electronic device that is under the control of the individual;
while screening the individual for admittance into said controlled area, scanning said electronic device that is under the control of the individual to retrieve the authenticating information for confirming the identity of the individual, obtaining a skin temperature reading for the individual, and capturing a facial image of the individual to determine if the individual is wearing a protective face mask, and;
generating a signal for authorizing admittance of the individual into said controlled area if the authenticating information retrieved from said electronic device matches the transmitted authenticating information, if the obtained skin temperature reading for the individual is within an acceptable temperature range, if the captured facial image confirms that the individual is wearing the protective face mask.
